(19) United States
(12) Patent Application Publication
(10) Pub. No.: US 2009/0205375 A1
(43) Pub. Date: Aug. 20, 2009

(54) OPTICAL ELEMENT PRESSING APPARATUS

(75) Inventor: Sunao Miyazaki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 12/429,780

(22) Filed: Apr. 24, 2009

Related U.S. Application Data
(63) Continuation of application No. PCT/JP07/70850, filed on Oct. 25, 2007.

(30) Foreign Application Priority Data
Oct. 25, 2006 (JP) 2006-290260

(51) Int. Cl. C03B 37/14

(52) U.S. Cl. 65/500

(57) ABSTRACT

In an apparatus for press-molding an optical element by pressing a glass material with a plurality pairs of upper dies and lower dies, a lower die pressure applier is operable to apply pressure to the lower dies. A body die is adapted to guide the upper dies and the lower dies. A pressure generator is operable to lift the body die. An aligner is operable to slide the body die along the upper dies to align each of the upper dies. The aligner has a hunger supporting each of the upper dies in a hanging manner, and is operable to cause each of the upper dies to move in a plane which perpendicularly intersects a movement axis of the body die, when the body die is lifted along the upper dies by the pressure generator.

### TECHNICAL FIELD

The present invention relates to an apparatus for press-molding optical elements, and particularly, to an apparatus for press-molding optical elements that is used when high-precise optical elements, such as aspheric lenses, are press-molded.

### BACKGROUND ART

In recent years, it attracts attention a method for precisely press-molding optical glass elements (e.g., glass lenses) in which the faces of the molded grass optical elements can be used as they are without being polished. Generally, in order to execute the above method, it is used a press-molding apparatus that press-molds a glass material in a softened state within a body die by using a molding die that is slid with respect to the body die, to form an optically-functioning face corresponding to a die face of the molding die in the glass material. The important thing herein is that, when products are relatively small, productivity is low if molding is performed by one set of dies by one press-molding apparatus. Thus, a method of producing a plurality of optical elements at the same time by mounting a plurality of dies on one press-molding apparatus is proposed.

When the plurality of dies are pressed at the same time, a contrivance for obtaining optical elements with high molding precision is required. As this method, a method of pressing a plurality of dies using a pressing member, such as a flat plate, which is fixed to an integral pressing shaft so as to be orthogonal to the sliding direction of the dies, is primarily considered. If this method is used, the stroke of all the dies will be determined on the basis of a die having the shortest stroke, among a plurality of dies. For this reason, in order to form optical elements in which the thickness and the face angle are controlled in the order of micrometers, it is necessary to sufficiently control the dimension of each die, the dimension of the pressing member, tilting angle at the time of attachment and pressing of the pressing member, and the wear of a contact portion of the pressing member with the die so that all strokes may fall within standards. However, it is almost impossible in view of the fact that deformation of the molding apparatus is also occurred when the molding apparatus is placed in the hundreds-degrees (Celsius) environment to perform the molding. Therefore, it will be necessary to butt an upper die, which is a die for molding, against a body die, and to guarantee the above precision in terms of the precision of the constructional members of the upper die, the body die, and other dies.

However, since the strokes of all the dies are the same in the above method, it is also almost impossible to always move down all the pressing members thoroughly. Alternatively, there may be a method in which the pressing member is not fixed but is provided with some degrees of freedom to follow the stroke. However, when a plurality of dies, especially four or more dies are pressed at the same time, all the dies cannot be moved down thoroughly unless the heights of the dies are aligned on the same plane when they are moved down thoroughly. Further, since the positions at which pressure application is started and the molding speeds (deformation speeds of glass) are different from one die from another die due to variations in the dimensions of materials to be molded, subtle temperature differences between dies during the application of pressure, or the like, the phenomenon that the dies are pressed in a state where the pressing member is tilted with respect to the sliding direction of the dies occur frequently. For this reason, a pressing force acts in directions other than the sliding direction of the dies, and seizing or damage of the dies are apt to occur. Furthermore, the contact portions between dies and the pressing member are always rubbed together, and are thereby apt to be worn. Particularly under such high temperature, the wear becomes severe. As a result of the wear, the vicious cycle that seizing or damage of the dies is further promoted are repeated.

Further, in the above molding apparatus, it is necessary to heat or cool the body die, the upper die, and the lower die with a fairly high and low temperature difference for the temperature control of a glass material in a press-molding process. Thus, the body die, the upper die, and the lower die are made of a material having almost the same coefficient of thermal expansion, and the clearance for securing sliding of the upper die and the lower die with respect to the body die is provided. For this reason, for example, when a glass material is press-molded between the moved-down upper die and the lower die, if pressing pressure is not applied to the center of the upper die, the upper die is tilted while sliding within the body die. As a result, it is not possible to press-mold a glass material in a state where the upper die and the lower die oppose each other correctly. Furthermore, in an extreme case, seizing occurs between the body die and the upper die, so that the upper die cannot be correctly set with respect to the body die. As a result, normal pressing operation is no longer performed. In other words, the center of the optically-functioning face of the molded optical element will not coincide with its optical axis. Further, when the upper die is pulled up in order to take out a molded element from the dies, if the pull-up force deviates from the center of the upper die, the upper die is tilted, and seizing occurs between the body die and the upper die, so that setting and releasing of the upper die are not allowed. In such molding apparatus, particularly, the clearance of a sliding portion between the body die and the upper die is as small as less than 10 μm in actually used conditions. Moreover, the seizing occurs more easily from the relationship that the apparatus is used under the high-temperature environment.

There is a molding apparatus described in Japanese Patent No. 2815037 (Patent Document 1) as an example in which the drawbacks of the above-mentioned conventional technique are solved to some extent. In the molding apparatus of Patent Document 1, by splitting one pressing shaft that applies pressure to the upper die into an upper shaft and a lower shaft, and stacking and disposing a plurality of disc springs between the upper shaft and the lower shaft, even if the heights of dies during application of pressure differ, pressing pressure is applied to each die uniformly by absorbing the difference of the heights by deformation of the disc springs.

However, in the molding apparatus of Patent Document 1, the disc springs are in a portion near the upper die. Thus, there is a drawback that the disc springs are exposed to high temperature, and loosened. In order to compensate for this drawback, it is necessary to water-cool the portions of the disc springs. In this case, however, the drawback that members are enlarged and complicated for additionally providing a water-cooling mechanism. Furthermore, since the water-cooled members contact the upper die during molding, there is also a drawback that the temperature of the upper die drops rapidly, and the molding become unstable.

Further, since a plurality of upper dies and lower dies are set in one body die for the purpose of cost-down, it is not economical to take a long distance between the die sets. For this reason, even if the distance between the die sets is large, the distance is typically tens of millimeters, and it is necessary to provide a disc spring in each shaft corresponding to this distance. Typically, since the pressure required for press-molding of glass is about 4.9 kN in a metal die of +18, the strength of a spring used for the disc spring needs to be 4.9 kN or more. A spiral spring of 4.9 kN to be received in a space of tens of millimeters does not exist typically. Therefore, although the disc springs are used in Patent Document 1, it is necessary to stack a plurality of disc springs in order to receive a spring of capacity of 4.9 kN in a narrow space even if the disc springs are used. As a result, a drawback that a spring mechanism is considerably lengthened occurs, and consequently the molding apparatus is enlarged. Further, when it is necessary to change the size of a lens to be pressed differently from an original schedule, and to greatly change pressing pressure, it is necessary to replace the disc springs to change a spring constant. In this case, disassembling parts that receive the stacked disc springs and replacing the disc springs require considerable time and efforts. As described above, even in the molding apparatus of Patent Document 1, there is still a problem. In addition, Patent Document 1 has no description about pressure distribution in case the lower die slides in the body die and performs pressing. If pressing is made by the lower die, it is inferred that a mechanism does not perform pressure distribution.

### DISCLOSURE OF THE INVENTION

The invention has been made in view of the above circumstances. An object of the invention is to provide an apparatus for press-molding optical elements capable of efficiently manufacturing high-precise optical elements by always causing the force of an operating member applied to a body die to act so as to pass through the center of an upper die, at least when the body die slides with respect to the upper die, and a glass material is press-molded, and when a molded product as an optical element is separated from the dies.

Further, another object of the invention is to provide an apparatus for press-molding optical elements capable of thoroughly pressing all materials to be molded when a body die slides with respect to a plurality of upper dies, and capable of making adjustment in accordance with a difference even if the starting positions of pressure application or the molding speed (deformation speeds of glass) differs between dies due to variations in the dimensions of the materials to be molded, subtle temperature differences between dies during the pressure application, or the like.

In order to achieve the above objects, according to the invention, there is provided an apparatus for press-molding an optical element by pressing a glass material with a plurality pairs of upper dies and lower dies, the apparatus including: a lower die pressure applier, operable to apply pressure to the lower dies; a body die, adapted to guide the upper dies and the lower dies; a pressure generator, operable to lift the body die; and an aligner, operable to slide the body die along the upper dies to align each of the upper dies, the aligner comprising a hunger supporting each of the upper dies in a hanging manner, and operable to cause each of the upper dies to move in a plane which perpendicularly intersects a movement axis of the body die, when the body die is lifted along the upper dies by the pressure generator.

The press-molding apparatus may further comprise an upper die pressure distributor, comprising levers respectively pressing the upper dies downward to apply pressure to each of the upper dies independently.

The press-molding apparatus may further comprise a lower die pressure distributor, comprising levers respectively pressing the lower dies upward to apply pressure to each of the lower dies independently.

The upper die pressure distributor may comprise rocking members each of which is rockably supported by a fulcrum, and has one end brought into contact with an upper end of one of the upper dies and the other end coupled with a spring member, so as to press the one of the upper dies downward and pressure applied to the one of the upper dies is adjusted by compressing the spring member.

The lower die pressure distributor may comprise rocking members each of which is rockably supported by a fulcrum, and has one end brought into contact with a lower end of one of the lower dies and the other end coupled with a spring member, so as to press the one of the lower dies upward and pressure applied to the one of the lower dies is adjusted by compressing the spring member.

The fulcrum in the upper die pressure distributor may be displaceable, thereby the pressure applied to the one of the upper dies is variable without replacement of the spring member.

The fulcrum in the lower die pressure distributor may be displaceable, thereby the pressure applied to the one of the lower dies is variable without replacement of the spring member.

The spring member may be a coiled spring.

The press-molding apparatus may further include: an upper die pressure distributor, operable to distribute the pressure generated by the upper die pressure generator to each of the upper dies; and a lower die pressure distributor, operable to distribute the pressure generated by the lower die pressure generator to each of the lower dies.

According to the apparatus for pressing-molding an optical element according to the invention, since the aligner is provided, when press-molding is performed by a plurality of upper dies and lower dies at the same time, the force applied to the upper dies can always support each die in place, and when the body die is lifted, the force can be made to act towards the center of the movement axis of the body die, and high-precision optical element, in which an optically-functioning face is correctly located with respect to an optical axis without no trouble such as seizing, can be manufactured efficiently.

Further, in the present the invention, a pressure distributor having levers is provided. Thus, when a body die having a plurality of guide holes slides with respect to a plurality of upper dies, and a glass material is press-molded, all the upper dies can be pressed thoroughly. Moreover, even if the starting position of application of pressure or the speed (deformation speed of glass) of molding differs between dies due to variations in the dimensions of the molding raw materials, subtle temperature differences between dies during the application of pressure, or the like, adjustment can be made accordingly. Thus, the precision of molded products becomes good, and productivity also improves.

### BRIEF DESCRIPTION OF THE DRAWINGS

FIG. 1 shows an entire configuration of a press-molding apparatus for an optical element according to an embodiment of the invention.

FIG. 2 is a structural view of main parts of the press-molding apparatus.

FIG. 3 is a perspective view of a suction pad that sucks and conveys a glass material in the press-molding apparatus.

FIG. 4 is an explanatory view showing an air flow passage from a rotary pump in the press-molding apparatus.

FIG. 5 is a sectional view showing the positional relationship between upper died, a body die, and upper die pressing rods in the press-molding apparatus.

FIG. 6 is a perspective view of a aligner in the press-molding apparatus.

FIG. 7 is a perspective view of the aligner.

FIGS. 8A and 8B are perspective views showing the disassembled state and assembled state of the aligner.

FIG. 9 is a structural view of a pressure adjuster of a lower die in the press-molding apparatus.

FIGS. 10A to 10D are explanatory views showing the operation of press-molding by the press-molding apparatus.

FIG. 11 is a structural view of a glass heating mechanism in the press-molding apparatus.

FIG. 12 is a side view when a member for preventing the molded product from sticking to the upper die in the press-molding apparatus is viewed from the lateral direction.

FIG. 13 is a side view when the member for preventing the molded product from sticking to the upper die in the press-molding apparatus is viewed from above.

FIG. 14 is a longitudinal sectional view showing a press-molding apparatus related to another embodiment of the invention.

FIG. 15 is a plan view of a body die in the press-molding apparatus.

### BEST MODE FOR IMPLEMENTING THE INVENTION

Embodiments of the invention will be described below in detail with reference to the accompanying drawings.

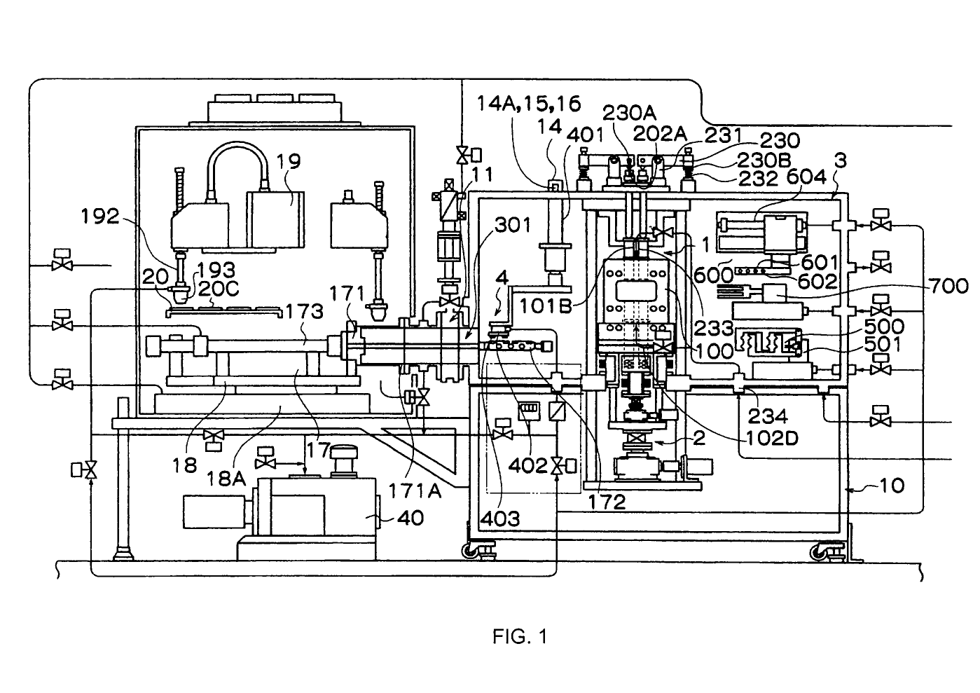

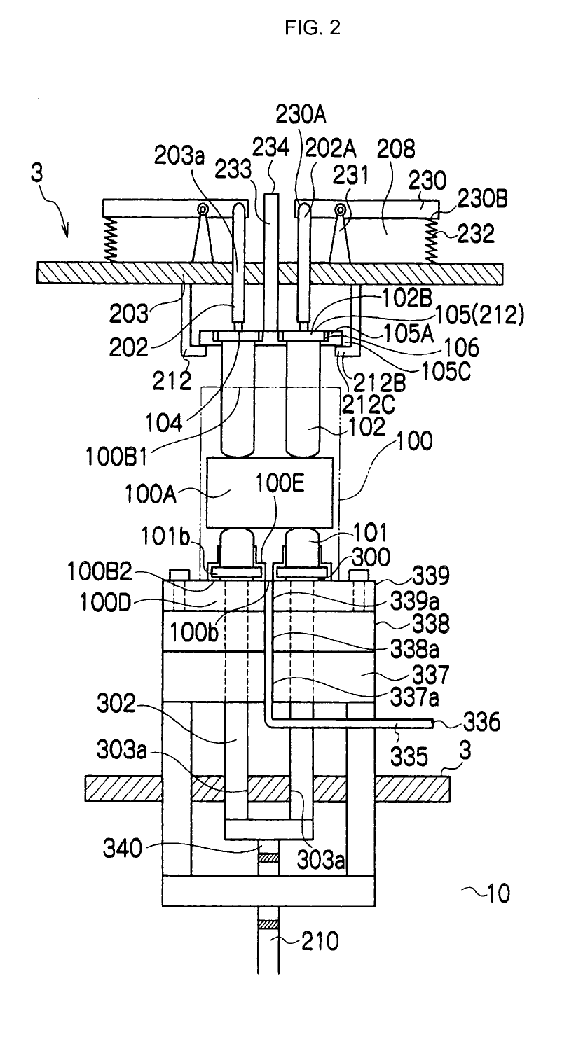

FIG. 1 shows a whole press-molding apparatus according to an embodiment of the invention, and FIG. 2 shows the structure of main parts of the press-molding apparatus. The press-molding apparatus shown in these drawings loads a glass material (glass blank) into a molding die 1, and pushes up a body die (to be described later) of the molding die 1 by the operation of a pressing mechanism 2, thereby performing press-molding. This press-molding is preferably performed in inert gas atmosphere, such as nitrogen gas atmosphere. For this purpose, the molding die 1, the pressing mechanism 2, and the like are equipped inside a molding chamber 3 having an airtight structure.

The molding chamber 3 is arranged on a mount 10, and a gate 301 for carrying in a glass material G and carrying out a molded product is equipped with a gate valve 11. The molding chamber communicates with the outside via the gate. Further, an exchanger 4 for performing loading of a glass material G into the molding die 1 and unloading of a molded product is equipped inside the molding chamber 3. The exchanger 4 is constructed by mounting a suction hand 402 serving as a glass loader/unloader on a lower end of a rotary shaft 401 that is vertically penetrating the ceiling of the molding chamber 3, and by providing suction pads 403 at a end of the suction hand 402. The rotary shaft 401 is rotatably connected with a piston rod 14A of an electric cylinder mechanism 14 provided on the ceiling of the chamber 3. The rotary shaft 401 is vertically moved by the operation of the piston rod 14A, and is rotated by an electric motor 15 via a gear train 16 which are provided in the piston rod 14A. In FIG. 1, the reference numerals 14A, 15, and 16 designate the same part.

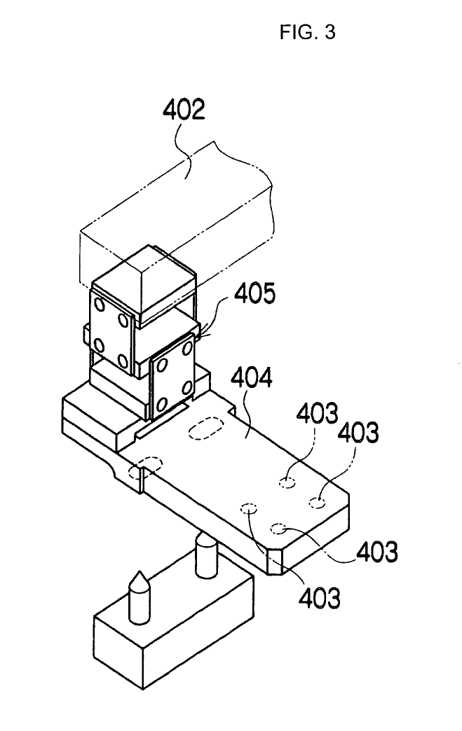

As shown in FIG. 3, a suction finger 404 having the suction pads 403 at the end of the suction hand 402 holds the suction pads 403 serving as a loader via a horizontal compliance spring part 405 at the end of the suction hand 402. Further, positioning holes used when the vertical operation is performed is provided in the suction finger 404. On the other hand, a guide member having positioning pins to be inserted into the positioning holes is provided in the body die for molding. The horizontal compliance spring part 405 is comprised of three-stage, i.e., upper, middle, and lower holding blocks, a pair of leaf springs that are laid between the upper and middle holding blocks, and a pair of leaf springs that have an angle difference of about 90 degrees from the above leaf springs and are laid between the middle and lower holding blocks. Since the horizontal compliance spring part is structured to couple the leaf springs with the upper, middle, and lower holding blocks, coupling members made of a material having a larger coefficient of thermal expansion than the coefficients of thermal expansion of the leaf springs and holding blocks are used. Further, a butting member that regulates the amount of vertical operation is arranged between the loader and the guide member. The suction pads 403 are made of a material having low thermal conductivity in order to prevent a molded product from being cracked due to heat shock, and is made of a heat-resistant material in order to suck a hot molded product. As an example thereof, polyimide resin is used.

Accordingly, in a state where a glass material G is sucked on the suction pads 403, it is introduced into the molding die 1 by the control of the cylinder mechanism 14, and by the axial operation and rotational operation of the rotary shaft 401 based on the rotational control of the electric motor 15. Further, in a state where a molded product is sucked by the suction pads 403, it is taken out of the inside of the molding die 1 by the reverse axial operation and rotational operation of the rotary shaft 401.

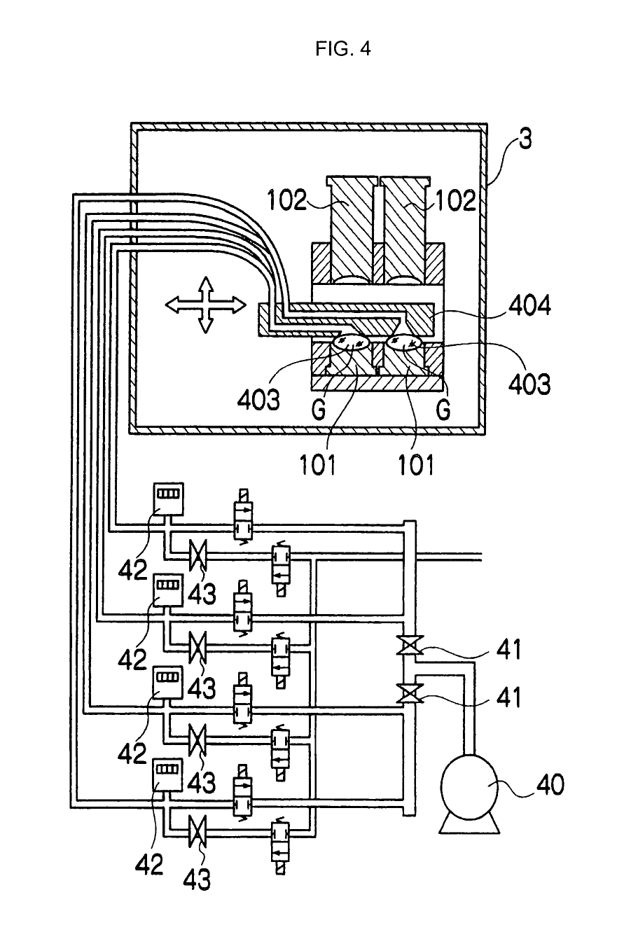

The suction pads 403 are configured so as to be able to perform suction or suction release independently in correspondence with four dies, and a suction source is a rotary pump 40 used for substitution of nitrogen (N₂) in the molding chamber 3. Sub-lines branched from the rotary pump 40 communicate with the suction pads 403. As shown in FIG. 4, throttle members 41 that regulate flow rate are arranged in a ratio of one per two of four sub-lines such that the suction pressure of each of the four sub-lines is controlled semi-independently. Since the four sub-lines are equipped with pressure detectors 42, respectively, pressure-holding control can be made without difficulty even if suction pressure is semi-independent. A mechanism that reversely ejects nitrogen is attached for the vacuum break for releasing suction force, and throttle members 43 are arranged in the four sub-lines, respectively so that they can control reverse ejection force independently in each line.

A loader/unloader 17 for a glass material G and a molded product with respect to the molding chamber 3 is located at a side face of the gate 301 of FIG. 1, and is arranged on the mount 10. In the loader/unloader 17, a piston rod 18A that extends horizontally from a cylinder mechanism 18 is mounted with an exchange chamber 171. Further, a rest 172 that can enter and leave the exchange chamber from side to side through an opening 171A at one end of the exchange chamber 171 is provided so that the rest 172 can be horizontally moved by a horizontal conveyer (for example, piston cylinder mechanism) 173 provided inside the exchange chamber 171.

Thus, when the glass material G or molded product is carried into or carried out of the molding chamber 3, with the glass material G being put on the rest 172, the piston rod 18A is operated by the control of the cylinder mechanism 18 to horizontally move the exchange chamber 171, thereby bringing the opening 171A into airtight contact with the gate valve 11. In this state, after the inside of the exchange chamber 171 is vacuumed by the vacuum pump 40, the atmosphere of the exchange chamber is replaced with nitrogen atmosphere, the gate valve 11 is opened, the molding chamber 3 and the exchange chamber 171 communicate with each other, the rest 172 is introduced into the molding chamber 3 by the horizontal conveyer 173, and transfer of a glass material G and receipt of a molded product are performed with respect to the exchanger 4. Thereafter, the horizontal conveyer 173 is operated reversely, the rest 172 is returned to the exchange chamber 171, the gate valve 11 is closed, the exchange chamber 171 is horizontally moved by the operation of the cylinder mechanism 18, and unloading of a molded product from the rest 172 and loading of a new glass material G thereto are performed.

In the present embodiment, a robot 19 is used for loading of a glass material G to the rest 172, and unloading of a molded product therefrom. The robot 19 transfers a glass material G to the rest 172 from a stocker 20 using a sucking device or the like, and transfers a molded product to a prescribed point from the rest 172. That is, although FIG. 1 shows that the robot 19 is a scalar robot, the invention is not limited thereto, and an X-Y robot may be used.

### (Description of Molding Apparatus)

Next, a molding apparatus will be described with reference to FIGS. 2, 4, 5, 6, 7, 8A and 8B.

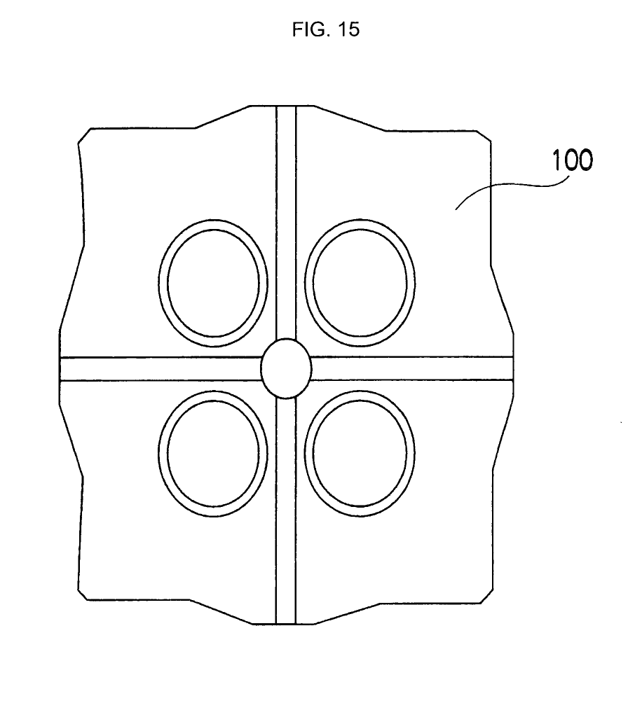

A bottom plate 339 that is screw-coupled with the body die 100 via a heat insulator 338 is placed above a body die base plate 337 of FIG. 2, and the bottom plate 339 is screw-coupled with the body die base plate 337 via the heat insulator 338. The body die 100 forms a non-rectangular parallelepiped as clear from a plan view shown in FIG. 15, and has an opening 100A formed in such a sheet penetrating direction of FIG. 2, and has four through holes formed in the opening 100A in the shape of a rectangular parallelepiped, and an upper ceiling portion 100B1. Four upper dies 102 are fitted into the through holes, respectively. Further, holes into which four lower dies 101 that make die sets with the upper dies 102 are fitted are formed in a bottom 100B2 in the shape of a non-rectangular parallelepiped, of the body die 100. The reason why the bottom is formed in the shape of a non-rectangular parallelepiped is in order to remove portions other than the portion through which a heater is inserted to such an extent that a required strength can be maintained, for reducing the heat capacity of the body die 100.

Cutout portions 101E are formed in the bottom 100B2 of the body die 100, and lifters 300 are arranged in the cutout portions 100E, respectively. Each lower die 101 is placed on each of the lifters 300. Each lifter 300 serves to compensate variations in the axial dimensional accuracy of each lower die 101.

In the configuration of the present embodiment, four molded products are at the same time press-formed by die sets of a plurality of, i.e., four upper and lower dies. As will be described later, it is required that a total load of, for example, 19.6 kN is applied to the four upper dies 102, and equal loads are applied to the upper dies 102, respectively. However, the four die sets may deviate to some extent in the movement stroke for glass molding of the body die 100 and the lower dies 101 due to variations in the finishing accuracy of the dimensions of individual members of the upper dies 102, the lower dies 101, and the body die 100. The lifters 300 are provided for adjustment of this stroke.

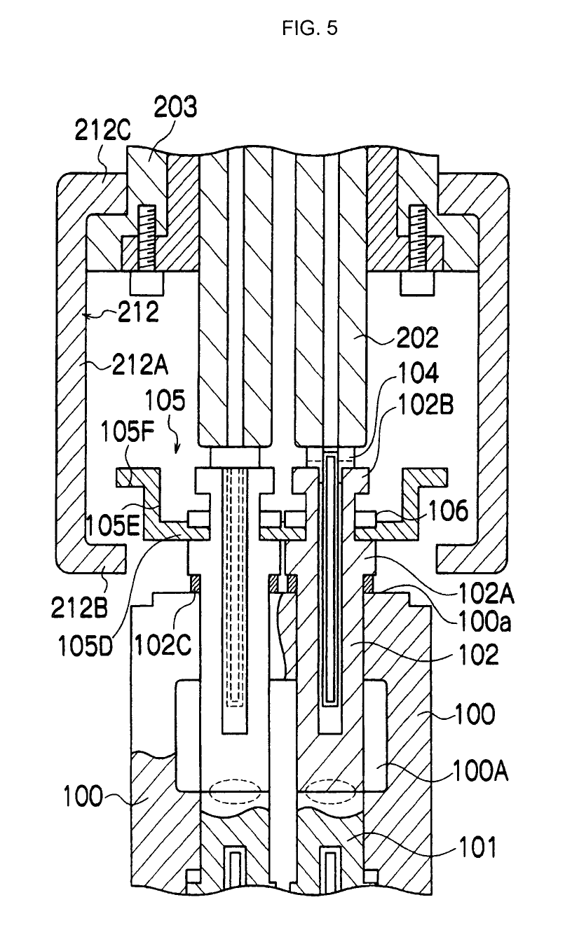

Meanwhile, a hole that supplies nitrogen gas for cooling is provided in the center of a bottom plate 100D. The nitrogen gas that is blown against the bottom plate 100D is blown against each lower die 101 along a passage provided in the bottom plate 100D, and is further discharged to the outside of the body die 100 by the passage provided in the bottom plate 100D. As shown in FIG. 5, a large-diameter portion 102A is formed in each upper die 102, and a flange portion 102B is formed at an upper end of the upper die. Further, reference numeral 105 designates a hanger for hanging the four upper dies 102 at the same time. The hanger is comprised of a disk portion 105D, a tubular portion 105E, and a flange portion 105F, and four holes for allowing the four upper dies 102 to be fitted thereinto are formed in the disk portion 105D.

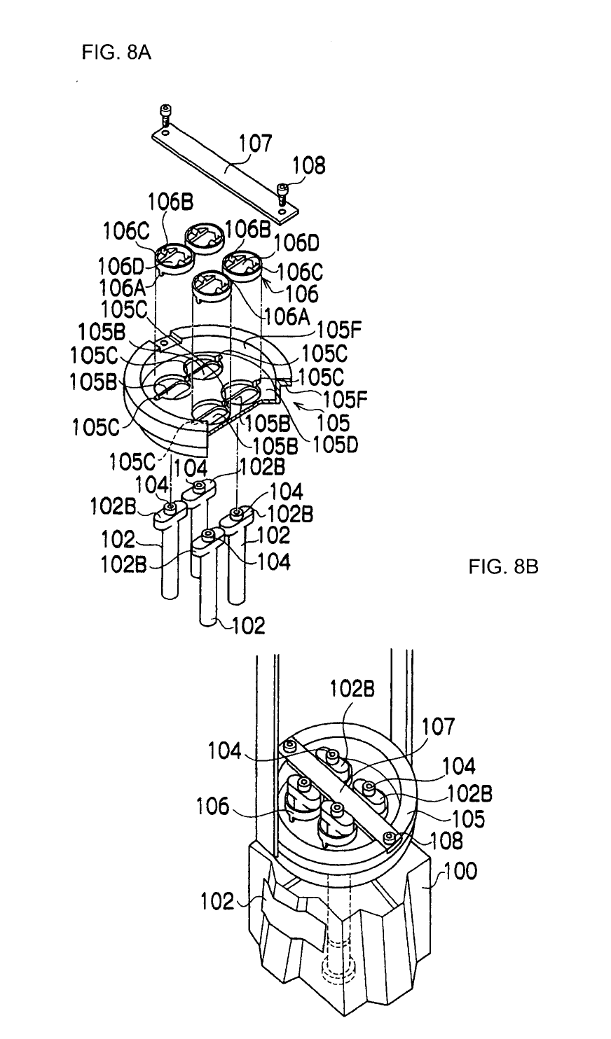

In FIG. 5, each upper die 102 has a circular section, and an abutment piece 104 having a small diameter is located in the center of the upper die, and is mounted on the apex of the upper die. When the body die 100 is moved upward, it receives pressing pressure at its center. Further, the flange portion 102B having a noncircular section is located in the upper portion of the upper die 102 and is formed as shown in FIGS. 8A and 8B, and the dish-shaped hanger 105 is put on the afore-mentioned large-diameter portion 102A. An aligner 106 is interposed between the flange portion 102B and the hanger 105 so that hanging force may act in the center of the upper die 102. As shown in FIGS. 8A and 8B, since a belt-shaped rotation stopper 107 is fixed to the hanger 105 with screws 108 such that it crosses the center of the hanger 105, the side face of the rotation stopper is caused to correspond to the side face of each flange portion 102B, and the rotation of the upper die 102 with respect to the hanger 105 is stopped. Also, the hanger 105 is formed with insertion holes 105B through which each flange portion 102B is inserted with a posture in a direction orthogonal to a rotation stop position.

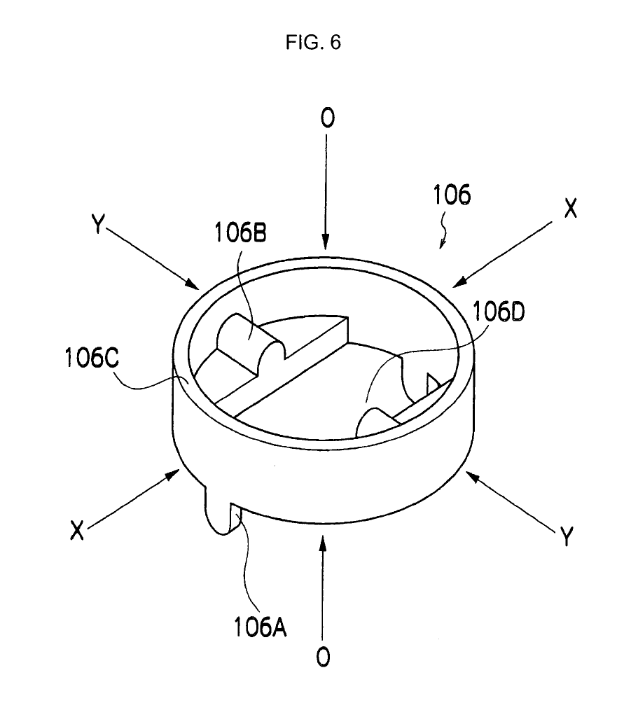

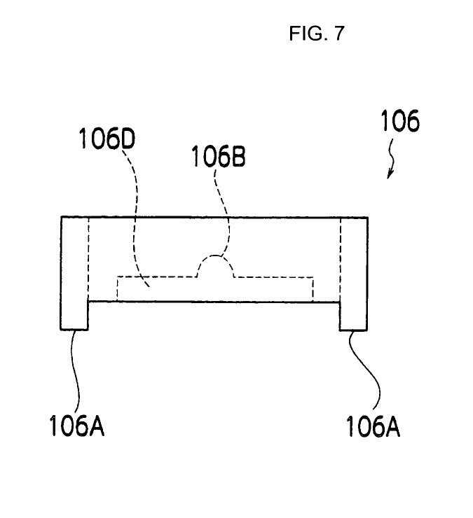

As for the aligner 106, as shown in FIGS. 6 and 7, a ring 106C is provided with a pair of supporting portions 106A and a pair of supporting portions 106B that are formed in the shape of a semi-spherical projection and are arranged in a plane orthogonal to the sliding direction of the upper die 102 so as to shift from one another by 90 degrees in the circumferential direction of the aligner 106. The supporting portions 106A are adapted to oppose the hanger 105, and the supporting portions 106B are adapted to oppose the upper die 102. Further, as shown in FIGS. 7, 8A and BB, an insertion hole 106D through which the flange portion 102B of the upper die 102 is inserted is formed in the center of the ring 106C.

Further, supporting slots 105C that receive the supporting portions 106B are formed in the hanger 105.

When an upper die 102 is assembled to the hanger 105 and the aligner 106, first, the flange portion 102B of the upper die 102 is inserted through the insertion holes 105B and 106D from below, and is caused to extend upward of the aligner 106. In this state, the flange portion 102B is turned by 90 degrees, and the lower face of the flange portion is caused to be supported by the supporting portions 106A. Thereafter, the relative position between the upper die 102 and the aligner 106 can be held by attaching the rotation stopper 107 to the hanger 105. In this case, the relative position between the hanger 105 and the aligner 106 is ensured as the supporting portions 106B are inserted through supporting slots 105C.

Reference numeral 212 of FIG. 2 designates a hook member for hanging and fixing the hanger 105 within the chamber 3, and is comprised of a supporting portion 212A, a lower end hook portion 212B, and an upper end hook portion 212C as shown in FIG. 5. The lower end hook portion 212B is engaged with the flange portion 105C of the hanger 105, and the upper end hook portion 212C is configured so as to be engageable with a holder block 203.

A number of molding processes are at the same time performed by a plurality of sets of upper dies 102 and lower dies 101. In the molding apparatus of the present embodiment, after glass is press-molded by four upper dies 102 and four lower dies 101 to form lenses, the operation of moving down the body die 100 and taking out a molded product remaining on each lower die 101 through the opening 101A of the body die 100 is performed in order to take out a lens as a molded product from between each set of upper and lower dies.

In the present embodiment, alignment of each of the four upper dies 102 is performed by the aligner 106. That is, if the body die 100 is moved downward, the flange portion 105F of the hanger 105 will hit the lower end hook portion 212B, and the hanger 105 will not move downward from there.

In FIGS. 8A and 8B, when the hanger 105 is fixed, and the body die 100 is moved downward, the faces of the hanger 105 and the aligner 106 in the direction of the plane X-X with respect to the axis O-O of FIG. 6 will be brought into point contact with each other by the supporting portions 106A of the lower face of the aligner 106. Furthermore, the faces of the hanger and the aligner in the direction Y-Y orthogonal to the direction X-X are brought into point contact with each other by the contact between the supporting portions 106B of the upper face of the aligner 106, and the flange portion 102B of the upper die 102. Accordingly, the upper die 102 is held in place in a state where the two planes X-X and Y-Y orthogonal to the axis O-O in the direction in which the body die 100 is moved downward are kept orthogonal to each other. Accordingly, when the body die 100 is moved downward, the tilt of the body die 100 with respect to the axis O-O of the upper die 102 can be prevented, and the seizing during sliding of the body die 100 can be prevented.

When the body die 100 is moved downward in a state where each upper die 102 is held by the hook member 212 of FIG. 2, a molded product is then taken out, and a glass material G is again placed on each lower die 101 and is again press-molded, the body die 100 is moved upward in a state where the upper die 102 is held by the hook member 212. Accordingly, the body die 100 is moved upward via the hanger 105 and the aligner 106 while each through hole thereof comes into sliding contact with the upper die 102 as a guide. At this time, the upper die 102 does not operate but is fixed substantially in place. In this case, it is necessary to slide the body die 100 without being seized between each of the four upper dies 102 and the body die 100. This is allowed by the aforementioned operation of the aligner 106.

In a state where the body die 100 is moved downward, each upper die 102 is held by the hanger 105 and the aligner 106 with the two planes X-X and Y-Y orthogonal to the axis O-O of FIG. 6 being orthogonal to each other. If the body die 100 is moved upward from this state, the upper die 102, the aligner 106, and the hanger 105 will be held substantially in place by their self-weights and the aforementioned orthogonal state will be maintained during the ascent of the body die 100. Thus, the seizing can be prevented.

Reference numeral 104 of FIG. 2 designates a abutment piece provided in an upper face of the flange portion 102B of each upper die 102, and a member that allows the pressing load of an upper die pressing rod 202 to be described later to act in a concentrated manner in the axial direction of the upper die 102. Each abutment piece 104 is configured so that the total height with each upper die 102 may equal. Further, the hook member 212 is fixed to the chamber 3 by the holder block 203. Four through holes 203a are formed in the chamber 3, and the upper die pressing rods 202 are inserted through the through holes 203a, respectively. The lower end of each of the four upper die pressing rods 202 is abutted (including a case where a very small gap is formed. The same is true hereinbelow) on the abutment piece 104 as mentioned above. An upper end 202A of each of the rods is located outside the chamber 3, and is in contact with one end 230A of a lever rod 230 provided in an outside upper portion of the chamber 3.

The lever rod 230 is rockably supported by a fulcrum member 231, and the other end 230B which is an end opposite to the end 230A adapted to come in contact with the upper end 202A of the upper die pressing rod 202 is fixed to the chamber 3 via a compression spring 232. The upper die pressing rod 202, the lever rod 230, the fulcrum member 231, and the compression spring 232 constitute a pressure adjuster for an upper die 102. Further, reference numeral 233 designates nitrogen cooling pipe provided in the middle of the four upper die pressing rods 202. An upper end of the cooling pipe is coupled with a cooling-medium supplying port 234 provided in the chamber 3, and a lower end thereof faces the upper center of the body die 100, so that nitrogen gas cooling can be performed along a groove for nitrogen gas provided in the body die 100.

### (Pressure Adjuster of Upper Die)

A pressure adjuster (upper die pressure distributor) 208 of an upper die 102 is comprised of the upper die pressing rods 202, the lever rods 230, the fulcrum members 231, and the compression springs 232. One of the objects of the invention is to provide an apparatus that obtains a number of molded products at the same time by a plurality of sets of upper and lower dies. For that purpose, it is necessary to cause the pressing load required for four die sets to act uniformly. In the apparatus shown in FIG. 2, the pressure of a body die lifting cylinder 210 is caused to act on the four upper dies 102 via the body die 100. The pressure that has acted on the four upper dies 102 pushes up the ends 230A of the lever rods 230 via the four upper die pressing rods 202, and at the same time pushes down the ends 230B to compress the compression springs 232. In this case, it is desirable to constitute the pressing force (total load is 19.6 kN) of the body die lifting cylinder 210 so that the load of 4.9 kN may be caused to uniformly act on each upper die 102. If variations occur in the load distributed to each upper die 102, the quality of four molded products (for example, variations in lens wall thickness by pressing) will be influenced. Further, it is natural that there are also variations in the dimensions of upper and lower dies of each of the four die sets, the upper die pressing rods 202, and the like, and accordingly, a difference is caused in the pressing stroke of each die by the pressing force of the body die lifting cylinder 210.

In order to heat and press a glass material and to form a high-precision optical element, it is necessary to cause high pressure (3.92 to 5.88 kN) to be generated in each upper die 102, and to transmit the pressure to each upper die 102 via the above individual members from the body die lifting cylinder 210. Furthermore, in an apparatus using a method of repeating the process of taking out a molded product after a glass material is heated and press-molded to a predetermined temperature (400 to 800° C.) within the die, it is required that a heating-cooling-heating cycle is shortened in order to repeat heating and cooling of the molded product, die members, the body die, etc. Thus, it is necessary to reduce the heat capacity of the whole molding apparatus, and therefore, it is necessary to miniaturize the apparatus.

Each upper die 102 is pressed by the upper die pressing rod 202 and the ascending body die 100, which are shown in FIG. 5, and an upper end face 100a of the body die 100 is pressed against a lower end face of the large-diameter portion 102A of each upper die 102 via a spacer 102C, thereby regulating the movement position of the body die 100 to set the thickness of a molded product.

The whole upper end face 10a of the body die 100 hits the four upper dies 102 via the spacers 102C. This is a condition that is required to obtain the same molded products, for example, lenses having the same thickness, by four die members. For that purpose, it is necessary to cause a pressing force to independently act on the four upper dies 102, to cause the upper end face 10a of the body die 100 to completely hit each upper die 102, and to cause a sufficient pressing force to act on the upper dies 102.

In the present embodiment, in order to solve the above problems, the pressure adjuster (upper die pressure distributor) 208 in which a spring member, particularly, the compression spring 232 shown in FIG. 2 is installed outside the chamber 3 in order to generate the pressing force of the body die 100 is provided. That is, the pressure adjuster 208 is configured by brining the ordinary compression spring 232 and the upper die pressing rod 202 into contact or connection with the lever rod 230 supported by the fulcrum member 231 as shown in FIG. 2.

If a pressing force acts on the body die 100 from the body die lifting cylinder 210 (refer to FIG. 2: upper die pressure-generator), pressing is started by the upper dies 102 and lower dies 101 that ascend along with the body die 100, and the upper die pressing rods 202 are pushed up via the upper dies 102 by this operation to push up the lever rods 230. Accordingly, the compression springs 232 are compressed. As the pressing proceeds, the upper dies 102 are moved while they are brought into sliding contact with the through holes of the body die 100, and movement of the body die 100 is performed until the upper end face 100a of the body die 100 abuts on the large-diameter portion 102A of each upper die 102. While the upper end face 100a of the body die 100 is abutted on the large-diameter portions 102A of the upper dies 102 of three die sets in the four die sets, even if the upper end face 10a is not abutted on the large-diameter portion 102A of the other one die set, the upper end face 10a of the body die 100 can be pressed against the non-abutted upper die 102 as the compression springs 232 are compressed via the upper die pressing rods 202 by the pressing from the body die lifting cylinder 210. Accordingly, since all the positions of the four upper dies 102 can always be secured in places, the thickness of molded products can be maintained.

Next, a specific example of each compression spring 232 will be described. That is, one rectangular wire spring made of silicon chrome steel wire having an external diameter of φ18 mm, an internal diameter of φ9 mm, a spring constant of 44.1 Ns/mm, a maximum load of 568 N, and a free height of 45 mm was used, a fulcrum member 231 supporting a lever rod 230 was set so that the ratio of the distance to an upper die pressing rod 202 and the distance to a compression spring 232 may be set to 1:10, and individual members were assembled. As a result, a pressure adjuster that endures a load of 10 times the maximum load of the compression spring 232 by the lever's principle (5.68 kN in this case) was constructed. By constructing four such compression springs so as to correspond to the upper dies 102, four pressure adjusters are completed (they endure up to 22.7 kN in total pressure). Consequently, since it is not necessary to provide a lot of disc springs as in the molding apparatus of Patent Document 1 in which disc springs are assembled into a chamber, there is no need for adjustment. Further, since the compressing springs are installed outside the chamber, there is a margin of space, and design becomes easy. Further, it is not necessary to cool the compression spring 232.

The same configuration is allowed even in a compression spring 232 using an ordinary piano wire. Specifically, one rectangular wire spring made of a piano wire having an external diameter of φ28 mm, an internal diameter of φ4.5 mm, a spring constant of 68.6 Ns/mm, a maximum load of 862 N, and a free height of 40 mm was used, the position of a fulcrum member 231 supporting a lever rod 230 was set so that the ratio of the distance to an upper die pressing rod 202 and the distance to a compression spring 232 may be set to 1:6, and individual members were assembled. As a result, a pressure adjuster that endures a load of 6 times the maximum load of the compression spring 232 by the leverage principle (5.17 kN in this case) was constructed. By constructing four such compression springs so as to correspond to the upper dies 102, four pressure adjusters are established (they endure up to 20.7 kN in total pressure). In this state, when the thrust (the total of the pressing force applied to the four upper dies 102) of the body die lifting cylinder was set to 19.6 kN, and the pressure variation between the upper die pressing rods 202 was measured, it was confirmed that the variation falls within a range of 98 N. Thereafter, using a die set in which the variation of the height to the abutment piece 104 was adjusted to less than 0.2 mm, lenses for video cameras having a finish dimension of φ10 mm, a center thickness of 3.5 mm, and a lens face curvature of 15 or 20 mm were formed under a body die ascent pressure of 19.6 kN that is one of molding conditions. As a result, pressing can be completely performed at the same time without any troubles such as seizing in the four dies, and molded products that coincident with the cavities formed by individual dies and sufficiently satisfy thickness accuracy and the allowed value of an optical face were obtained.

### (Pressing Mechanism for Lower Die)

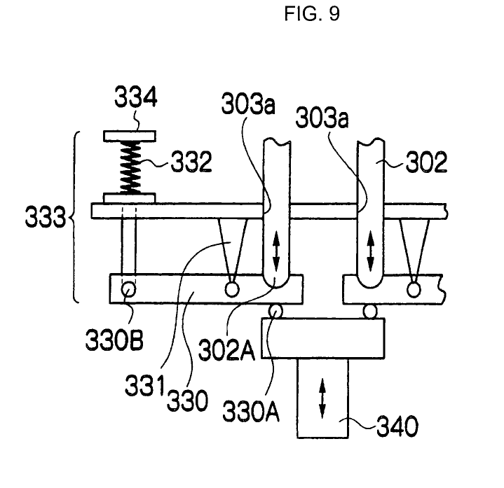

A pressing mechanism (lower die pressure distributor) for the lower die is shown in FIG. 9, reference numeral 300 of FIG. 2 designates a lifter provided in an upper face of a flange portion 101b of each lower die 101, and a member that allows the pressing load of a lower die pressing rod 302 to act in a concentrated manner in the axial direction of each lower die 101. Each lifter 300 is configured so that the total height with each lower die 101 may equal. As shown in FIG. 2, four through holes 303a are formed in the chamber 3, and the lower die pressing rods 302 are inserted through the through holes 303a, respectively. The upper end of each of the four lower die pressing rods 302 is close to the lifter 300 as mentioned above. A lower end 302A of each of the rods is located outside 3 as shown in FIG. 9, and is in contact with one end 330A of a lever rod 330 connected to a fulcrum member 331 provided in the middle of a body die lifting cylinder outside the chamber 3. The lever rod 330 is connected with a compression spring unit 333 at the other end 330B which is an end opposite to one end 330A that is adapted to come in contact with the lower end 302A of the lower die pressing rod 302. The compression spring unit 333 is comprised of a compression spring 332 and a compression spring holder 334. Further, reference numeral 335 designates nitrogen cooling pipe provided in the middle of the four lower die pressing rods 302. An upper end of the cooling pipe is coupled with a cooling-medium supplying port 336 provided in the chamber 3, and the other end thereof faces the lower center of the body die 100 through holes 337a, 338a, and 339a passing through a base plate 337, a heat insulator 338, and a bottom plate 339, so that nitrogen gas cooling can be performed along a groove for nitrogen gas provided in the body die 100.

### (Pressure Adjuster for Lower Die)

A pressure adjuster for the lower die 101 is comprised of the lower die pressing rods 302, the lever rods 330, the fulcrum members 331, the compression springs 332, and the compression spring holders 334 as shown in FIG. 9. The lower die pressing rod 302 is biased downward by the biasing force of the compression spring 332.

One of the objects of the invention is to provide an apparatus that obtains a number of molded products at the same time by a plurality of sets of upper and lower dies. For that purpose, it is necessary to cause the pressing load required for four die sets to act uniformly during cooling. In the apparatus shown in FIG. 2, the pressure of a lower die lifting cylinder 340 (lower die pressure generator) is caused to act on the four lower dies 102 via the body die 100. The pressure of the lower die lifting cylinder 340 pushes up one end 330A of each of the four lever rods 330, and at the same time pushes up the lower end 302A of the lower die pressing rod 302. At that time, the other end 330B of the lever rod 330 is moved downward by way of the fulcrum member 331, and at the same time the compression spring 332 is compressed. In this case, it is desirable to constitute the pressing force (total load is 9.8 kN) of the lower die lifting cylinder 340 so that the load of 2.45 kN may be caused to uniformly act on each lower die. If variations occur in the load distributed to each upper die 101, the quality of four molded products (for example, variations in lens wall thickness by pressing) will be influenced. Further, it is natural that there are also variations in the dimensions of upper and lower dies of each of the four die sets, the lower die pressing rods 302, and the like, and accordingly, a difference is caused in the moving stroke of each die by the pressing force of the body die lifting cylinder 340.

In order to heat and press a glass material of the invention and to form a high-precision optical element, it is necessary to cause high-pressure (0.98 to 3.92 kN) to be generated in each lower die 101, and to transmit the pressure to each lower die 101 via the above individual members from the lower die lifting cylinder 340. Furthermore, in an apparatus using a method of repeating the process of taking out a molded product after a glass material is heated and press-molded to a predetermined temperature (400 to 800° C.) within the die, it is required that a heating-cooling-heating cycle is shortened in order to repeat heating and cooling of the molded product, die members, the body die, etc. Thus, it is necessary to reduce the heat capacity of the whole molding apparatus, and therefore, it is necessary to miniaturize the apparatus.

Furthermore, in the molding apparatus of the present embodiment, in order to obtain the same molded products, for example, lenses having the same thickness, by four die members, molded products are pressed in the upper dies 102 and the lower dies 101 by the lower die pressing rods 302 and the ascending lower dies 101, which are shown in FIG. 9, and the thicknesses of the molded products are set without pressing the lower dies 101 against the body die 100. Accordingly, in order to equalize the push-in quantity of the molded products during cooling, the absolute condition is that pressure is uniformly divided into four partial pressures.

For that purpose, it is necessary to cause equal pressing forces to act on the four lower dies 101 independently, and to cause sufficient pressing force to act on each lower die 101.

In the present embodiment, in order to solve the above problems, the pressure adjuster in which a spring member, particularly, the compression spring 332 shown in FIG. 9 is installed outside the chamber 3 in order to generate the pressing force of the lower die lifting cylinder 340 is provided. While pressure is applied to only the lower dies 101 of three die sets in the four die sets, even if pressure is not applied to the other one die set, the pressure from the lower die lifting cylinder 340 can be caused to act on the non-abutted lower die 101 as the load of the compression spring 332 is applied by way of the lower die pressing rod 302. Accordingly, since the pressure applied to the four lower dies 101 can always be secured uniformly, the thickness of molded products can be maintained.

Next, a specific example of the compression spring 332 will be described. That is, one rectangular wire spring made of silicon chrome steel wire having an external diameter of φ18 mm, an internal diameter of φ4.9 mm, a spring constant of 23.5 Ns/mm, a maximum load of 382 N, and a free height of 45 mm was used, the position of the fulcrum member 331 supporting the lever rod 330 was set so that the ratio of the distance to an upper die pressing rod 202 and the distance to a compression spring 232 may be set to 1:7, and individual members were assembled. As a result, a pressure adjuster that endures a load of 7 times the maximum load of the compression spring 332 by the lever's principle (2.68 kN in this case) was constructed. By constructing four such compression springs so as to correspond to the lower dies 101, four pressure adjusters are established (they endure up to 10.7 kN in total pressure). Consequently, since it is not necessary to provide a lot of disc springs as in the molding apparatus of Patent Document 1 in which disc springs are assembled into a chamber, there is no need for adjustment. Further, since the compressing springs are installed outside the chamber, there is a margin of space, and design becomes easy. Further, it is not necessary to cool the compression spring 332.

The same configuration is allowed even in a compression spring using an ordinary piano wire. Specifically, one rectangular wire spring made of a piano wire having an external diameter of φ25 mm, an internal diameter of φ3.5 mm, a spring constant of 28.4 Ns/mm, a maximum load of 0.49 N, and a free height of 40 mm was used, the position of a fulcrum member 330 supporting a lever rod 331 was set so that the ratio of the distance to a lower die pressing rod 302 and the distance to a compression spring 332 may be set to 1:6, and individual members were assembled. As a result, a pressure adjuster that endures a load of 6 times the maximum load of the compression spring 332 by the leverage principle (1.96 kN in this case) was constructed. By constructing four such compression springs so as to correspond to the lower dies 101, four pressure adjusters are completed (they endure up to 7.84 kN in total pressure). In this state, when the thrust (the total of the pressing force applied to the four lower dies 101) of the lower die lifting cylinder 340 was set to 6.86 kN, and the pressure variation between the lower die pressing rods 302 was measured, it was confirmed that the variation falls within a range of 98 N. Thereafter, using a die set in which the variation of the height to the abutment piece 104 was adjusted to less than 0.2 mm, lenses for video cameras having a finish dimension of φ10 mm, a center thickness of 3.5 mm, and a lens face curvature of 15 or 20 mm were formed under a body die ascent pressure of 19.6 kN that is one of molding conditions. As a result, pressing can be completely performed at the same time without any troubles such as seizing in the four dies, and molded products that coincident with the cavities formed by individual dies and sufficiently satisfy thickness accuracy and the allowed value of an optical face were obtained.

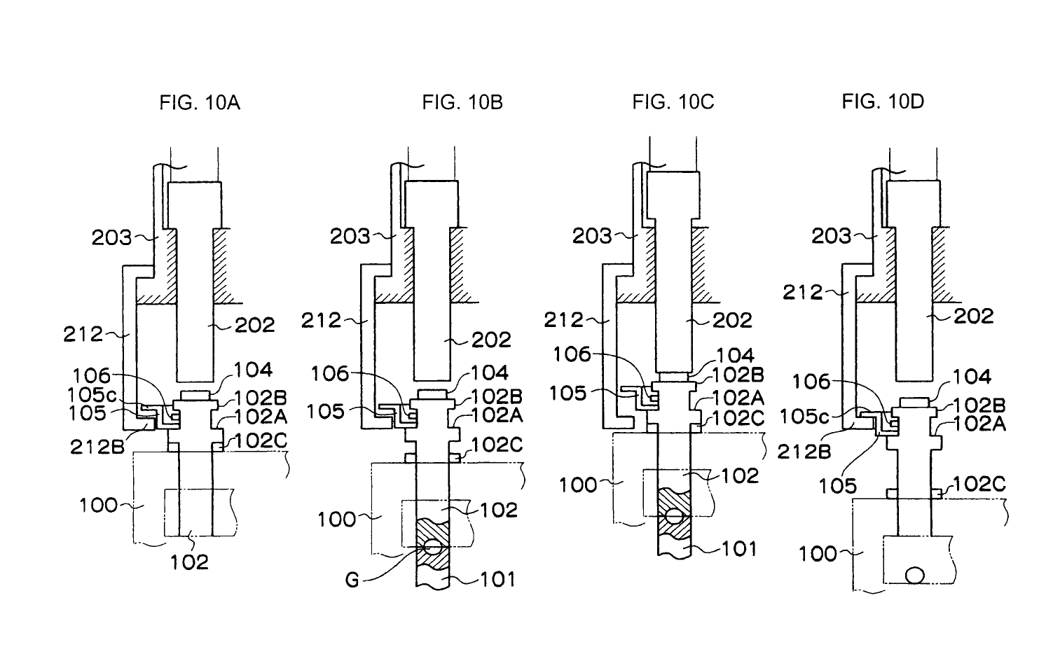

Thus, when a glass material G is press-molded using the pressing mechanism 2 of FIG. 2, first, if the upper die pressing rod 202 is moved downward by the cylinder mechanism 210 (refer to FIG. 2) from the state shown in FIG. 10A to lower the body die 100, the flange portion 105C of the hanger 105 will hit the lower end hook portion 212B. For this reason, the hanger 105 is not moved downward, and the upper die 102 is also not moved downward. This results so-called die opening. Then, the glass material G is introduced into the lower die 101 in the molding die 1 by the suction hand 402 shown in FIG. 3, and is heated by a heater.

Next, when the upper die pressing rod 202 is moved upward by the cylinder mechanism 210 to raise the body die 100, the glass material G will be pressed against the upper die 102 as shown in FIG. 10B.

Next, when the body die 100 is further moved upward by the cylinder mechanism 210, as shown in FIG. 10C, the upper die pressing rod 202 applies pressing pressure to the center of the upper die 102 via the abutment piece 104 (Thereafter, during cooling, the cylinder mechanism 340 pushes up the upper die pressing rod 202, and the lower die 101 is pressed upward via the lifter 300).

Accordingly, even if clearance required for sliding exists in a sliding portion between the body die 100 and the upper die 102, the body die 100 can be moved upward in a state where the posture of the upper die 102 is kept vertical. As a result, there is no positional deviation of the die faces of the upper die 102 and the lower die 101 in the horizontal direction, and molding can be made in a state where the position of an optically-functioning face with respect to the optical axis of a molded optical element is held correctly.

In particular, in the present embodiment, it is necessary to drive the body die 100 by the common cylinder mechanism 210 and to absorb the dimensional errors of the upper die 102 and the upper die pressing rod 202 from the relationship that pressing is at the same time made by the four upper dies 102. However, since the upper die pressing rod 202 is resiliently held by the pressure adjuster 208, as shown in FIG. 10C, even if the body die 100 is further moved upward after the upper end face 100a of the body die 100 is hit via the large-diameter portion 102A of the upper die 102, and the spacer 102C, the ascent can be terminated in the position.

Further, if the body die 100 is moved downward by the operation of the cylinder mechanism 210 in order to perform die opening after molding, as shown in FIG. 10D, the lower end hook portion 212B will hold the hanger 105, but at this time, the aligner 106 is operated to make an automatic alignment action. Accordingly, since the upper die 102 receives a holding force at the center thereof, the upper die is not tilted within the above clearance range. For example, even if the holder block 203, the hanger 105, and the flange portion 102B do not has sufficient precision with respect to the body die 100, the upper die 102 can be held in place, and the body die 100 can be vertically moved downward, without causing seizing.

In addition, in the present embodiment, the pressure distributor are provided in both the upper die 102 and the lower die 101. However, the invention is not limited thereto. Any pressure distributor may not be provided on both sides, or one pressure distributor may be provided in either the upper die 102 or the lower die 101.

### (Glass Heating Mechanism)

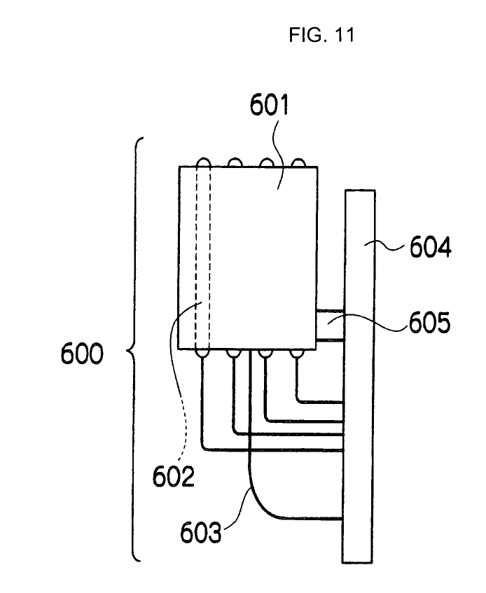

A glass heating mechanism is comprised of a glass heater 600 and a driving unit 604, as shown in FIG. 11. The glass heater 600 has a cartridge heater 602 built therein, is connected to an independent temperature regulator, and is controlled by a thermocouple 603 inserted into the glass heater 600. Since the glass heater 600 is set to an high temperature (for example, 900° C.), the heater is made of a material that endures the high temperature (for example, SKD61, SKD62, and Hastelloy, and more preferably Ambilloy, and cemented carbide). The driving unit 604 includes a connecting portion 605 that connects the heater unit 601 with the driving unit 604, and enables the glass heater 600 to be inserted through the opening of the body die.

Next, the process of molding a molded product as an optical element will be described in detail in order of loading, molding, and unloading mainly about the glass material G, using the press-molding apparatus according to the present embodiment. In addition, the molded optical element is an aspheric lens used for a camera, a video camera, etc.

The glass material G, which is a glass blank that is formed in advance in a spherical shape, is first placed on a pallet 20C of a stocker 20 of FIG. 1. Then, the robot 19 is operated to bring a suction band 193 to that position, and to suck and hold one glass material G from the pallet 20C. Next, the suction band 193 puts the above glass material G on the rest 172 by the operation of the robot 19. This is repeated four times, and thereby, four glass materials G are put on the rest 172. The glass material G on the rest 172, which is at a room temperature and is not warmed in advance, is carried into the molding chamber 3 by the operation of the loader/unloader 17 as mentioned above, is sucked and held by the suction pads 403 of the exchanger 4 made of polyimide resin, and is introduced into the molding die 1. Further, the upper die 102 and the lower die 101 are warmed in advance to, for example, a temperature of about 10¹⁶ poises in glass viscosity.

If the glass material G is introduced into the molding die 1, a glass material alignment mechanism 500 shown in FIG. 1 will be introduced into the molding die 1 to perform the alignment operation of the glass material G by the movement of a glass material alignment cylinder 501 so that the glass material may be located in the center of the lower die 101.

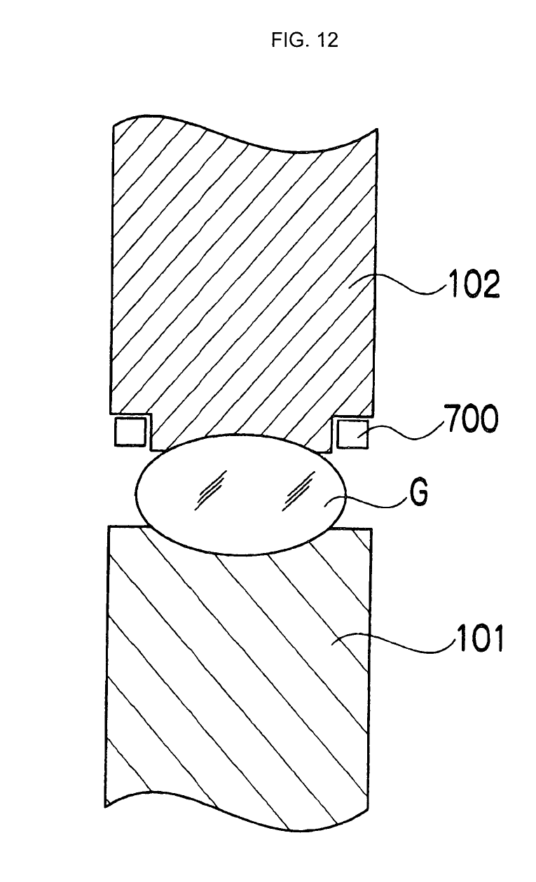

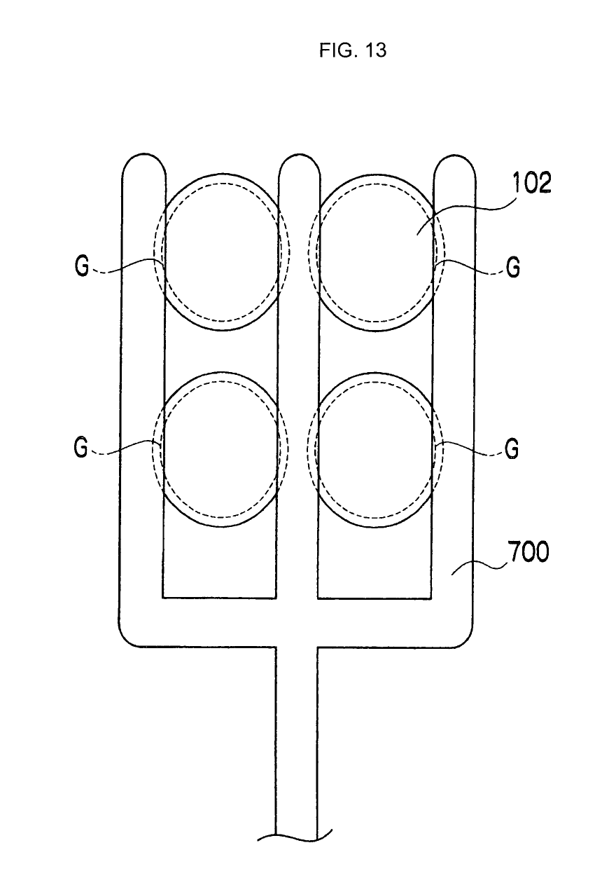

Then, the glass heater 600 held at 900° C. by the cartridge heater 602 is inserted between above the lower die 101 and the glass material G and below the upper die 102 through a window of the body die 100 by the operation of the cylinder mechanism 604. Further, the upper die 102 and the lower die 101 are heated to, for example, a temperature of about 10⁹ poises in glass viscosity by the cartridge heater provided in the body die 100. Meanwhile, the glass material G is heated to, for example, a temperature of about 10⁷ poises in glass viscosity by the glass heater 600. After the glass material G, the upper die 102, and the lower die 101 are warmed during a desired period of time (for example, 90 seconds), the cylinder mechanism 604 is operated to draw out the glass heater 400 through the window of the body die 100, and therefore, the body die lifting cylinder 210 is moved upward, for example, with the pressure of 196 MPa, thereby performing press-molding. After the flange portion 102A comes into contact with the upper end of the body die 100 via the spacer 102C sufficiently (for example, after 10 seconds), the heater of the body die 100 is turned off, a cooling medium is introduced into cooling-medium introducing portions 101B and 102D of the upper die 102 and the lower die 101, and pressing pressure is applied from below by the lower die 101 (for example, 98 MPa in total pressure) while the temperature of the upper die 102 and the lower die 101 is between about 10^{10.5} and 10¹³ poises in glass viscosity. Meanwhile, a sticking prevention member 700 (refer to FIG. 1) equipped with an insertion and retraction mechanism having a cylinder for preventing a molded product from being stuck to the upper die 102 during die opening is inserted between a recess of the upper die 102 and the molded product. Thereafter, after cooling is continued, and the temperature of the molded product becomes, for example, 10^{14.5} poises in glass viscosity, the body die 100 is moved downward (the sticking prevention member 700 is moved downward along with the body die 100), die opening is performed, the sticking prevention member 700 is retracted, and the molded product is taken out from between the lower die 101 and the upper die 102 by the suction pads 403. The relationship between the sticking prevention member 700, and the upper die 102 or the like is shown in FIGS. 12 and 13. FIG. 12 is a view when the sticking prevention member 700 is seen horizontally, and FIG. 13 is a view when the member is seen from above.

Thereafter, the molded product is returned to the rest 172 by the reverse operation of the exchanger 4, is taken out from the molding chamber 3 by the loader/unloader 17, and is further returned to the pallet 20C by the operation of the robot 19.

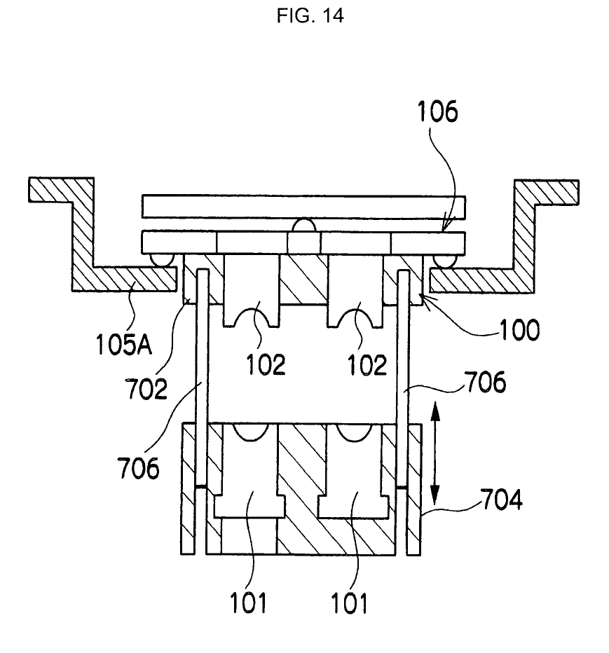

In the present embodiment, the molding die 1 is such that four (sets) upper dies 102 and lower dies 101 are operated within the common body die 100. However, the structure of the aligner 106 as mentioned above may be adopted for one upper die 102 and one lower die 101. In addition, in the present embodiment, the molding die 1 is such that four (sets) upper dies 102 and lower dies 101 are operated within the common body die 100. However, as shown in FIG. 14, the structure of a type in which the body die 100 is split into an upper body die 702 and a lower body die 704, four upper dies 102 are integrally held by the upper body die 702, and four lower dies 101 are integrally held by the lower body die 704, and the upper body die 702 and the lower body die 704 are slid along long pins 706 while being guided may be adopted. In this structure, the upper body die 702 is hung and supported by the aligner 106.

As described above, the hanger 105 corresponds via the abutment piece 104 so that the pressing pressure parallel to a sliding face with the body die 100 may act at least in the axial center of the upper die 102, and the hanger 105 hung and supported by the hook member 212 is interlocked via the aligner 106 so that a pull-down force may act in the axial center of the upper die 102. Thus, when a glass material G is press-molded, or when a molded product as an optical element is separated from the die, the force of body die upper and lower members applied to the upper die 102 can be made to act so as to pass through the center of the upper die 102, and a high-precision optical element in which an optically-functioning face is correctly located with respect to an optical axis can be manufactured efficiently.

According to the invention, it is possible to provide a molding die for an optical lens suitable for a precision press-molding method having excellent durability or die-releasing property from the optical lens. Further, since it is possible to press-mold an optical lens using the die of the invention, thereby manufacturing various optical elements after molding without performing polishing, etc., it is possible to provide an optical element manufacturing method having mass productivity, and having advantages in terms of cost.

1. An apparatus for press-molding an optical element by pressing a glass material with a plurality pairs of upper dies and lower dies, comprising:
a lower die pressure applier, operable to apply pressure to the lower dies;
a body die, adapted to guide the upper dies and the lower dies;
a pressure generator, operable to lift the body die; and
an aligner, operable to slide the body die along the upper dies to align each of the upper dies, the aligner comprising a hunger supporting each of the upper dies in a hanging manner, and operable to cause each of the upper dies to move in a plane which perpendicularly intersects a movement axis of the body die, when the body die is lifted along the upper dies by the pressure generator.

2. The press-molding apparatus according to claim 1, further comprising:
an upper die pressure distributor, comprising levers respectively pressing the upper dies downward to apply pressure to each of the upper dies independently.

3. The press-molding apparatus according to claim 1, further comprising:
a lower die pressure distributor, comprising levers respectively pressing the lower dies upward to apply pressure to each of the lower dies independently.

4. The press-molding apparatus according to claim 2, wherein:
the upper die pressure distributor comprises rocking members each of which is rockably supported by a fulcrum, and has one end brought into contact with an upper end of one of the upper dies and the other end coupled with a spring member, so as to press the one of the upper dies downward and pressure applied to the one of the upper dies is adjusted by compressing the spring member.

5. The press-molding apparatus according to claim 3, wherein:
the lower die pressure distributor comprises rocking members each of which is rockably supported by a fulcrum, and has one end brought into contact with a lower end of one of the lower dies and the other end coupled with a spring member, so as to press the one of the lower dies upward and pressure applied to the one of the lower dies is adjusted by compressing the spring member.

6. The press-molding apparatus according to claim 4, wherein:
the fulcrum in the upper die pressure distributor is displaceable, thereby the pressure applied to the one of the upper dies is variable without replacement of the spring member.

7. The press-molding apparatus according to claim 5, wherein:
the fulcrum in the lower die pressure distributor is displaceable, thereby the pressure applied to the one of the lower dies is variable without replacement of the spring member.

8. The press-molding apparatus according to claim 4, wherein:
the spring member is a coiled spring.

9. The press-molding apparatus according to claim 1, further comprising:
an upper die pressure distributor, operable to distribute the pressure generated by the upper die pressure generator to each of the upper dies; and
a lower die pressure distributor, operable to distribute the pressure generated by the lower die pressure generator to each of the lower dies.
